(19) United States
(12) Patent Application Publication
(10) Pub. No.: US 2006/0170805 A1
(43) Pub. Date: Aug. 3, 2006

(54) CCD solid-state image pick-up device, analog signal processing system and analog signal processing method

(75) Inventors: Takayasu Kito, Takatsuki-shi (JP); Shinichi Ogita, Yawata-shi (JP); Kouji Yamaguchi, Tsuzuki-gun (JP); Naohisa Hatani, Kuze-gun (JP); Keijirou Itakura, Ibaraki-shi (JP); Mitsuhiko Otani, Amagasaki-shi (JP); Yasumasa Yoshikawa, Takatsuki-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/342,653

(22) Filed: Jan. 31, 2006

(30) Foreign Application Priority Data
Feb. 3, 2005 (JP) 2005-027786

(51) Int. Cl. H04N 5/335

(52) U.S. Cl. 348/311

(57) ABSTRACT

In a CCD solid-state image pick-up device according to the present invention, a solid-state image pick-up circuit formed by a sensor part, a horizontal transfer register part and a floating diffusion amplifier converts a photo signal into a voltage signal and outputs the voltage signal, and a voltage-current conversion circuit converts the voltage signal output from the solid-state image pick-up circuit into a current signal. A current-driven black signal component detect/remove circuit then removes a black signal component from the current signal output from the CCD solid-state image pick-up device, and an image signal component alone is output as a current image signal. A current-voltage conversion circuit converts the current image signal into a voltage image signal.

### BACKGROUND OF THE INVENTION

1. Field of the Invention

The present invention relates to a CCD solid-state image pick-up device.

The present invention further relates to an analog signal processing system for CCD solid-state image pick-up device which comprises a CCD solid-state image pick-up device, a black signal component detect/remove circuit which detects and removes a black signal from an output signal from the CCD solid-state image pick-up device, an amplifier circuit and a circuit which performs signal processing such as analog-digital conversion.

The present invention still further relates to an analog signal processing method for CCD solid-state image pick-up device.

2. Description of the Related Art

Generally, a CCD solid-state image pick-up device converts for each pixel a photo signal into electric charge information, propagates the electric charge information regarding each pixel, and an electric charge-voltage conversion circuit converts this into a voltage signal and outputs the voltage signal.

FIG. 11 shows a conventional CCD solid-state image pick-up device. In FIG. 11, denoted at 10 is the CCD solid-state image pick-up device. Denoted at 11 is a sensor part which converts for each pixel a photo signal into electric charge information. Denoted at 12 is a horizontal transfer register which makes the electric charge information regarding each pixel thus vertically transferred from the sensor part 11 propagate along the horizontal direction in accordance with external clocks. Denoted at 13 is a floating diffusion amplifier which accumulates thus propagating electric charge regarding each pixel within a capacitor Ca and converts the electric charge into a voltage signal.

As for the voltage signal output from the floating diffusion amplifier 13, since the output impedance of the floating diffusion amplifier 13 is small, a source follower circuit 17 converts the impedance. To this end, the source follower circuit 17 includes a transistor Qj, a current source BIAS4, a transistor Qk and a current source BIAS5. The conventional CCD solid-state image pick-up device 10 has the structure above.

An analog signal processing system for CCD solid-state image pick-up device generally has such a structure in which a buffer circuit receives the output signal from the CCD solid-state image pick-up device, and the signal is treated by impedance conversion and fed to a black signal component detect/remove circuit.

FIG. 12 shows a conventional analog signal processing system for CCD solid-state image pick-up device. In FIG. 12, denoted at 10 is a CCD solid-state image pick-up device having the same structure as that shown in FIG. 11. Denoted at 8 is a buffer circuit which converts the impedance of the output signal from the CCD solid-state image pick-up device 10. The buffer circuit 8 includes an emitter follower circuit which is formed by a transistor Qm and a resistor Rb.

Denoted at 9 is a voltage-driven black signal component detect/remove circuit which detects and removes a black signal from a voltage signal component which is output from the buffer circuit 8 and accordingly extracts an image component alone. The voltage-driven black signal component detect/remove circuit 9 includes for instance three sample hold circuits 101 through 103 and a comparator (differential amplifier) 104.

Denoted at 4 is an amplifier circuit which amplifies an analog image signal extracted by the voltage-driven black signal component detect/remove circuit 9. Denoted at 5 is an analog-digital conversion circuit which converts the analog image signal amplified by the amplifier circuit 4 into a digital image signal.

Denoted at 6 is a timing generator. The timing generator 6 outputs a timing signal which controls the CCD solid-state image pick-up device 10, the voltage-driven black signal component detect/remove circuit 9, the amplifier circuit 4 and the analog-digital conversion circuit 5.

The electric charge regarding each pixel vertically transferred from the sensor part 11 is transferred through the horizontal transfer register 12 in accordance with a horizontal transfer register control signal, and converted into a voltage signal by the floating diffusion amplifier 13. This voltage signal is output via the source follower circuit 17. The signal output from the source follower circuit 17 is a CCD solid-state image pick-up device output signal. The CCD solid-state image pick-up device output signal is sent to the voltage-driven black signal component detect/remove circuit 9 via the buffer circuit 8.

Next, the voltage-driven black signal component detect/remove circuit 9 detects the level of the black signal from the CCD solid-state image pick-up device output signal while the sampling signal S1 remains at the high level. Further, while the sampling signal S2 remains at the high level, the voltage-driven black signal component detect/remove circuit 9 compares the level of the image signal with the level of the black signal, and outputs a difference between the two. The amplifier circuit 4 amplifies utilizing the sampling signals S1 and S2. At last, the analog-digital conversion circuit 5 is driven in accordance with an analog-digital conversion control signal.

Use of a voltage-driven black signal component detect/remove circuit for signal processing in a CCD solid-state image pick-up device gives rise to the following problem. That is, since the impedance of an output from the CCD solid-state image pick-up device is low, an impedance conversion circuit is indispensable. To drive the impedance conversion circuit, it is necessary to apply a large voltage upon transistors which form a source follower circuit which is disposed as the last stage of an output part of the CCD solid-state image pick-up device and to flow a large current.

While a CCD solid-state image pick-up device is demanded to have a high pixel count and a compact size, heat developing in the last stage of the output part of the CCD solid-state image pick-up device influences a sensor part of the CCD solid-state image pick-up device and causes a white spot and shading, which is an increasing concern. In addition, an impedance conversion circuit itself needs a large current and a large voltage. Due to this, in a conventional circuit structure, an impedance conversion circuit consumes approximately 20% of the total electric power in an analog signal processing system for CCD solid-state image pick-up device. The impedance conversion circuit is thus an obstacle against realization of low electric power consumption.

Meanwhile, where a current-driven black signal component detect/remove circuit is used for signal processing in a CCD solid-state image pick-up device, there is a following problem. That is, in a current output part of a current-output type CCD solid-state image pick-up device black, an image signal component of an output from the CCD solid-state image pick-up device contains a reset pulse which is at a drive power source level, for the purpose of partitioning the signal for each pixel. Therefore, the structure in which the CCD solid-state image pick-up device output is connected directly with the current-driven black signal component detect/remove circuit accompanies starvation of an output current during the period of the reset pulse. In consequence, transistors which form the current output part take time until they come back to a state that they can output the current from the state that they are deprived of the output current. This leads to a problem of a distorted image signal waveform.

### SUMMARY OF THE INVENTION

An object of the present invention is to provide a CCD solid-state image pick-up device which is capable of reducing the amount of internal heat generation.

Other object of the present invention is to provide an analog signal processing system which as a whole realizes low electric power consumption.

Still other object of the present invention is to provide an analog signal processing method with which it is possible to reduce the amount of developed heat.

To solve the problems above, a CCD solid-state image pick-up device according to the first invention includes a solid-state image pick-up circuit which converts a photo signal into a voltage signal and outputs the voltage signal and a first conversion circuit which converts the voltage signal into a current signal and outputs the current signal.

This structure, equipped not with an impedance conversion circuit but with the first conversion circuit which converts the voltage signal into the current signal and outputs the current signal, is capable of reducing the amount of heat developing inside. This realizes low electric power consumption in the CCD solid-state image pick-up device. In addition, as the amount of developed heat is small inside the CCD solid-state image pick-up device, creation of a white spot and shading is suppressed.

In the CCD solid-state image pick-up device according to the first invention, the solid-state image pick-up circuit has a structure of converting the photo signal into an electric signal temporarily and converting this electric signal into the voltage signal for example.

The CCD solid-state image pick-up device according to the first invention preferably further includes a level shift circuit which is disposed between the solid-state image pick-up circuit and the first conversion circuit and which changes the level of a d.c. component of the voltage signal.

In this structure, an appropriately set amount of a level shift prevents a distortion during voltage-current conversion.

Alternatively, the CCD solid-state image pick-up device according to the first invention preferably further includes a clip circuit which is disposed between the solid-state image pick-up circuit and the first conversion circuit and which removes the voltage signal which exceeds a predetermined reference signal.

This structure makes it possible to remove a reset pulse, prevent current starvation during voltage-current conversion and obviate a distortion during voltage-current conversion.

Alternatively, the CCD solid-state image pick-up device according to the first invention preferably further includes a level shift circuit, which is disposed between the solid-state image pick-up circuit and the first conversion circuit and which changes the level of a d.c. component of the voltage signal, and a clip circuit which is disposed between the solid-state image pick-up circuit and the first conversion circuit and which removes the voltage signal which exceeds a predetermined reference signal.

Including the level shift circuit, this structure can avoid a distortion during voltage-current conversion when the amount of a level shift is set properly. Further, disposition of the clip circuit makes it possible to remove a reset pulse, prevent current starvation during voltage-current conversion and obviate a distortion during voltage-current conversion.

In the event that there are the level shift circuit and the clip circuit between the solid-state image pick-up circuit and the first conversion circuit, the level shift circuit may be connected either before or after the clip circuit.

An analog signal processing system according to the second invention includes a CCD solid-state image pick-up device, which is formed by a solid-state image pick-up circuit converting a photo signal into a voltage signal and outputting the voltage signal and a first conversion circuit converting the voltage signal into a current signal and outputting the current signal, a remove circuit which removes a black signal component from the current signal and outputs a current image signal consisting only of an image signal component, a second conversion circuit which converts the current image signal into a voltage image signal, an amplifier circuit which amplifies the voltage image signal, and an analog-digital conversion circuit which subjects the output signal from the amplifier circuit to analog-digital conversion.

The CCD solid-state image pick-up device having this structure, equipped not with an impedance conversion circuit but with the first conversion circuit which converts the voltage signal into the current signal and outputs the current signal, is capable of reducing the amount of heat developing inside the CCD solid-state image pick-up device. This realizes low electric power consumption in the CCD solid-state image pick-up device. In addition, as the amount of developed heat is small inside the CCD solid-state image pick-up device, creation of a white spot and shading is suppressed. This attains low electric power consumption in the analog signal processing system as a whole.

An analog signal processing system according to the third invention includes a CCD solid-state image pick-up device, which converts a photo signal into a voltage signal and outputting the voltage signal, a first conversion circuit connected with the CCD solid-state image pick-up device and converting the voltage signal into a current signal, a remove circuit which removes a black signal component from the current signal and outputs a current image signal consisting only of an image signal component, a second conversion circuit which converts the current image signal into a voltage image signal, an amplifier circuit which amplifies the voltage image signal, and an analog-digital conversion circuit which subjects the output signal from the amplifier circuit to analog-digital conversion.

This structure, equipped not with an impedance conversion circuit but with the first conversion circuit which converts the voltage signal into the current signal and outputs the current signal, is capable of reducing the amount of developed heat. This realizes low electric power consumption in the analog signal processing system as a whole. In addition, the reduced amount of developed heat suppresses a white spot and shading.

It is preferable that the analog signal processing system according to the third invention further comprises a level shift circuit which is disposed between the CCD solid-state image pick-up device and the first conversion circuit and which changes the level of a d.c. component of the voltage signal.

In this structure, an appropriately set amount of a level shift prevents a distortion during voltage-current conversion.

Alternatively, the analog signal processing system according to the third invention preferably further comprises a clip circuit which is disposed between the CCD solid-state image pick-up device and the first conversion circuit and which removes the voltage signal which exceeds a predetermined reference signal.

This structure makes it possible to remove a reset pulse, prevent current starvation during voltage-current conversion and obviate a distortion during voltage-current conversion.

Further alternatively, the analog signal processing system according to the third invention further comprises a level shift circuit, which is disposed between the solid-state image pick-up circuit and the first conversion circuit and which changes the level of a d.c. component of the voltage signal, and a clip circuit which is disposed between the solid-state image pick-up circuit and the first conversion circuit and which removes the voltage signal which exceeds a predetermined reference signal.

Including the level shift circuit, this structure can avoid a distortion during voltage-current conversion when the amount of a level shift is set properly. Further, disposition of the clip circuit makes it possible to remove a reset pulse, prevent current starvation during voltage-current conversion and obviate a distortion during voltage-current conversion.

In the event that there are the level shift circuit and the clip circuit between the solid-state image pick-up circuit and the first conversion circuit, the level shift circuit may be connected either before or after the clip circuit.

It is preferable that the analog signal processing system according to the second invention is a part of a camera system which includes a digital signal processing circuit which processes a digital signal.

It is preferable that the analog signal processing system according to the third invention is a part of a camera system which includes a digital signal processing circuit which processes a digital signal.

An analog signal processing method according to the fourth invention includes a step of extracting a photo signal as a voltage signal by a CCD solid-state image pick-up device, a step of converting the voltage signal into a current signal, a step of removing a black signal component from the current signal and outputting a current image signal consisting only of an image signal component, a step of converting the current image signal into a voltage image signal, and a step of amplifying the voltage image signal and subjecting the amplified signal to analog-digital conversion.

With this method, since the voltage signal is converted into the current signal instead of executing impedance conversion, it is possible to reduce the amount of heat which develops during analog signal processing of converting the photo signal into the voltage image signal. This realizes low electric power consumption in the circuit which performs the analog signal processing. In addition, the reduced amount of developed heat suppresses a white spot and shading.

As described above, the present invention is characterized in that the voltage-current conversion circuit is disposed to the output part of (inside) the CCD solid-state image pick-up device or external to the CCD solid-state image pick-up device.

In the event that the voltage-current conversion circuit is disposed to the output part of (inside) the CCD solid-state image pick-up device, it is desirable that the clip circuit or the level shift circuit or the both are disposed between the solid-state image pick-up circuit and the voltage-current conversion circuit inside the CCD solid-state image pick-up device. On the contrary, where the voltage-current conversion circuit is disposed outside the CCD solid-state image pick-up device, it is desirable that the clip circuit or the level shift circuit or the both are disposed between the solid-state image pick-up device and the voltage-current conversion circuit.

With this structure, it is possible to remove a reset pulse, which is unnecessary for image signal processing, out from the image signal and convert the image signal into the image signal component which has any desired d.c. component level. It is therefore possible for the voltage-current conversion circuit to convert the voltage signal, which is a CCD image signal which is free from a reset pulse and whose d.c. component level is adjusted, into a current component signal without distorting the waveform of the image signal.

The image signal which is a current signal can be connected directly with the black signal component detect/remove circuit, without using an impedance conversion circuit which is required by the conventional techniques. Hence, it is possible to eliminate an impedance conversion circuit which consumes 20% of the total electric power in a conventional analog signal processing system for CCD solid-state image pick-up device, and therefore, realize low electric power consumption.

Further, omission of an impedance conversion circuit allows omission of a source follower circuit which has been heretofore disposed inside a CCD solid-state image pick-up device, and hence, eliminates the necessity of using a large current in this portion. This suppresses heat which develops from the last stage of the output part of the CCD solid-state image pick-up device and removes the causes of white spots and shading.

Since the structure that the voltage-current conversion circuit is disposed to the output part of the CCD solid-state image pick-up device or external to the CCD solid-state image pick-up device eliminates a reset pulse and attains conversion to any desired d.c. signal level, there is no problem of current starvation which arises in a conventional structure, and therefore, distortion of a signal output does not occur.

Further, the structure of feeding the output of the CCD solid-state image pick-up device directly to the current-driven black signal component detect/remove circuit permits that the current-driven black signal component detect/remove circuit is driven with a small current. Hence, as compared with a conventional technique which requires use of a voltage-driven black signal component detect/remove circuit and insertion of a buffer circuit in front of an input part of the voltage-driven black signal component detect/remove circuit, it is possible to more greatly reduce the amounts of the voltage and the current in the last stage of the output part of the CCD solid-state image pick-up device and to lower consumption of electric power within the solid-state image pick-up device. In addition, the reduced amount of heat developing within the solid-state image pick-up device suppresses a white spot and shading.

Further, it is not necessary to dispose an impedance conversion circuit between the solid-state image pick-up device and the black signal component detect/remove circuit, which reduces approximately 20% of the total electric power in the analog signal processing system for the CCD solid-state image pick-up device.

As described above, according to the present invention, disposition of the voltage-current conversion circuit to the output part of the CCD solid-state image pick-up device or outside the CCD solid-state image pick-up device attains low electric power consumption in the CCD solid-state image pick-up device. In addition, the reduced amount of heat developing within the solid-state image pick-up device suppresses a white spot and shading.

### BRIEF DESCRIPTION OF THE DRAWINGS

FIG. 1 is a circuitry block diagram which shows the structure of a CCD solid-state image pick-up device according to the first embodiment of the present invention;

FIG. 2 is a circuitry block diagram which shows the structure of a CCD solid-state image pick-up device equipped with a level shift circuit according to the second embodiment of the present invention;

FIG. 3 is a waveform diagram which shows the waveforms of internal signals of the CCD solid-state image pick-up device according to the second embodiment of the present invention;

FIG. 4 is a circuitry block diagram which shows the structure of a CCD solid-state image pick-up device equipped with a clip circuit according to the third embodiment of the present invention;

FIG. 5 is a waveform diagram which shows the waveforms of internal signals of the CCD solid-state image pick-up device according to the third embodiment of the present invention;

FIG. 6 is a circuitry block diagram which shows the structure of a current-driven black signal component detect/remove circuit according to the fourth embodiment of the present invention;

FIG. 7 is a waveform diagram which shows the relationship between the waveform of an input to the current-driven black signal component detect/remove circuit of FIG. 6 and the waveform of a sampling signal;

FIG. 8 is a circuitry block diagram which shows the structure of an analog signal processing system for a CCD solid-state image pick-up device according to the fifth embodiment of the present invention;

FIG. 9 is a waveform diagram which shows the waveforms of signals generated by a timing generator in the fifth embodiment of the present invention;

FIG. 10 is a circuitry block diagram which shows the structure of a camera system according to the sixth embodiment of the present invention;

FIG. 11 is a circuitry block diagram which shows the structure of a conventional CCD solid-state image pick-up device; and

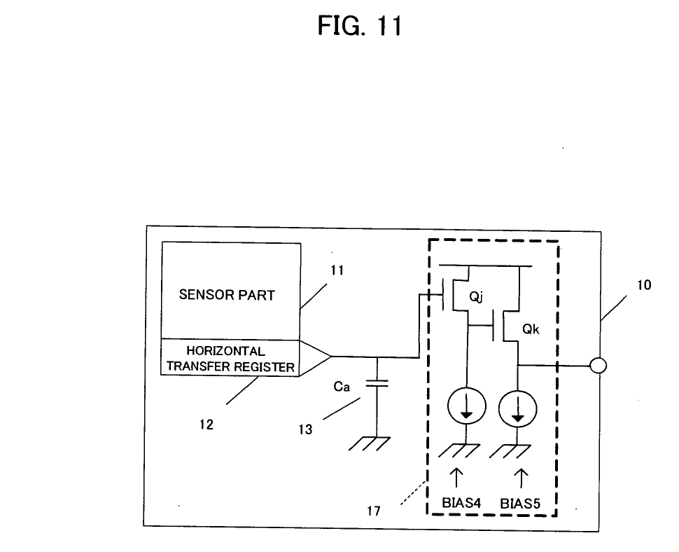

FIG. 12 is a circuitry block diagram which shows the structure of a conventional analog signal processing system for a CCD solid-state image pick-up device.

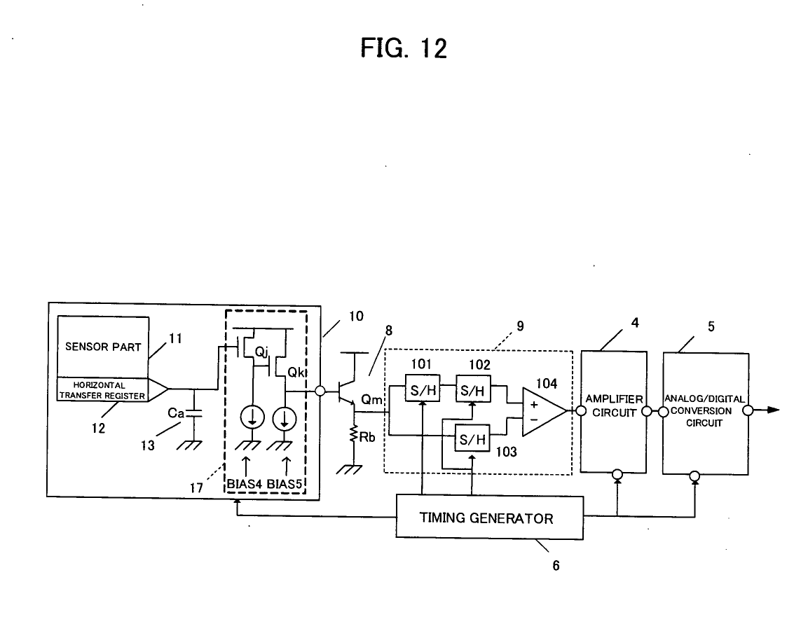

### DETAILED DESCRIPTION OF THE PREFERRED EMBODIMENTS

Preferred embodiments of the present invention will now be described with reference to the associated drawings.

### First Embodiment

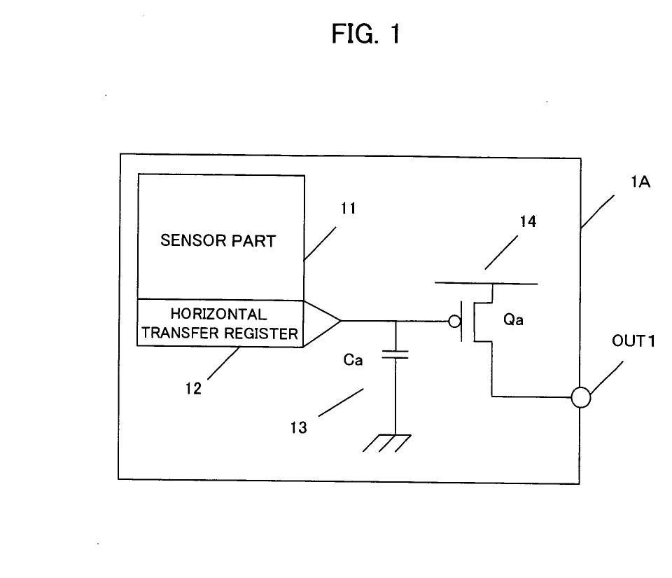

FIG. 1 is a circuitry block diagram which shows the structure of a CCD solid-state image pick-up device according to the first embodiment of the present invention. In FIG. 1, denoted at 1A is the CCD solid-state image pick-up device. Denoted at 11 is a sensor part. Denoted at 12 is a horizontal transfer register. Denoted at 13 is a floating diffusion amplifier. Denoted at 14 is a voltage-current conversion circuit formed by a transistor Qa. The sensor part 11, the horizontal transfer register 12 and the floating diffusion amplifier 13 form the solid-state image pick-up device. The voltage-current conversion circuit 14 corresponds to the first conversion circuit.

A photo signal is converted by the sensor part 11 into an electric signal (electric charge), transferred to the horizontal transfer register 12 and then further transferred by the horizontal transfer register 12 into the horizontal direction. The electric charge transferred by the horizontal transfer register 12 into the horizontal direction is accumulated in a capacitor Ca of the floating diffusion amplifier 13, and as such, taken out as a voltage signal. This voltage signal is converted by the voltage-current conversion circuit 14 into a current signal and output at an output terminal OUT1 as an external output which is in the form of a current.

Since this structure uses the voltage-current conversion circuit 14 instead of a source follower circuit which performs impedance conversion, it is possible to reduce the amount of heat which develops inside. This realizes low electric power consumption in the CCD solid-state image pick-up device. In addition, the reduced amount of heat developing within the CCD solid-state image pick-up device suppresses a white spot and shading.

### Second Embodiment

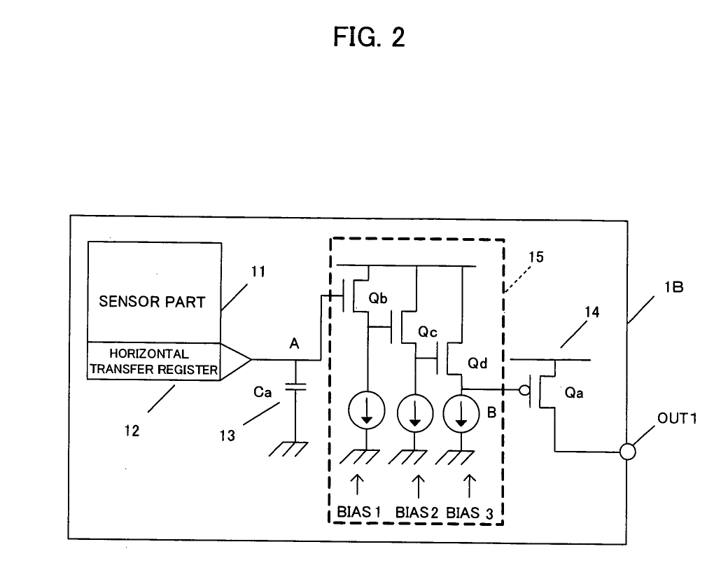

FIG. 2 is a circuitry block diagram which shows the structure of a CCD solid-state image pick-up device according to the second embodiment of the present invention. The same structures as those appearing in FIG. 1 will be denoted at the same reference symbols but will not be described again. In FIG. 2, denoted at 1B is the CCD solid-state image pick-up device. Denoted at 15 is a level shift circuit. In this level shift circuit 15, a gate terminal of an N-ch transistor Qb which is the first stage serves as an input terminal A, a drain terminal of the N-ch transistor Qb is connected with a power source, and a source terminal of the N-ch transistor Qb is connected with a current source BIAS1 and a gate terminal of an N-ch transistor Qc which is the second stage. A drain terminal of the N-ch transistor Qc which is the second stage is connected with the power source and a source terminal of this transistor is connected with a current source BIAS2 and a gate terminal of an N-ch transistor Qd which is the third stage. A drain terminal of the N-ch transistor Qd which is the third stage is connected with the power source, while a source terminal of this transistor is connected with a current source BIAS3 and serves as an output terminal B of the level shift circuit 15. The output terminal B is connected with a gate terminal of the transistor Qa.

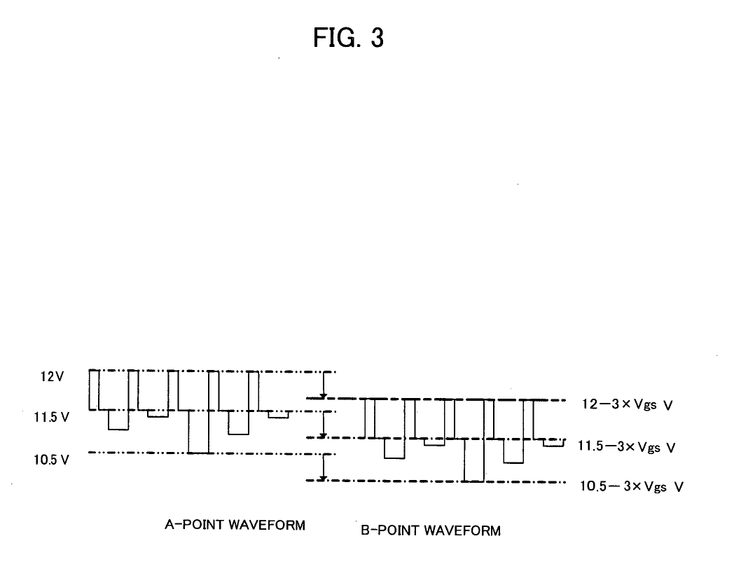

FIG. 3 shows the waveforms at the input terminal A and the output terminal B (i.e., the A-point waveform and the B-point waveform) of the level shift circuit 15. FIG. 3 shows the waveforms of internal signals of the CCD solid-state image pick-up device 1B which includes the level shift circuit 15. The signal fed at the input terminal A (the A-point waveform) is output (the B-point waveform) with its d.c. voltage component level shifted by an amount equivalent to a gate-source voltage Vgs across the three N-ch transistors Qb, Qc and Qd.

Owing to use of the level shift circuit 15, a voltage signal taken out due to the capacitor Ca of the floating diffusion amplifier 13 is output with its d.c. component changed to a different signal level. The voltage-current conversion circuit 14 outputs, as a current, the signal whose d.c. component is at the different signal level.

Since this structure uses the level shift circuit 15 to thereby change the signal level of the voltage signal, when the amount of a level shift is set properly, it is possible to prevent a distortion during voltage-current conversion.

### Third Embodiment

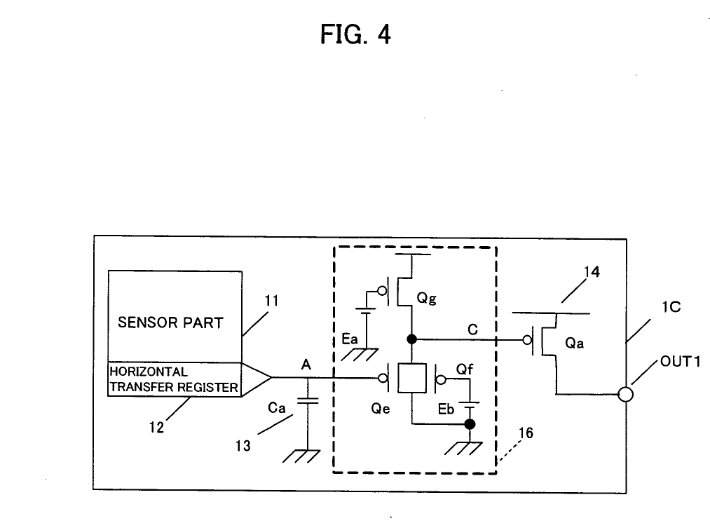

FIG. 4 is a circuitry block diagram which shows the structure of a CCD solid-state image pick-up device according to the third embodiment of the present invention. The same structures as those appearing in FIG. 1 will be denoted at the same reference symbols but will not be described again. In FIG. 4, denoted at 1C is the CCD solid-state image pick-up device. Denoted at 16 is a clip circuit. In the clip circuit 16, a gate terminal of a P-ch transistor Qe serves as the input terminal A, a drain terminal of the P-ch transistor Qe is grounded and a source terminal of the P-ch transistor Qe is connected with a drain terminal of a transistor Qg. A source terminal of the P-ch transistor Qg is connected with a power source, while a gate terminal of the P-ch transistor Qg is connected with a bias power source having a bias voltage Ea and forms a current source. A source terminal of a P-ch transistor Qf is connected with the source terminal of the transistor Qe, a drain terminal of the P-ch transistor Qf is connected with the drain terminal of the transistor Qe, and a gate terminal of the P-ch transistor Qf is connected with a bias power source having a bias voltage Eb. The drain terminal of the P-ch transistor Qg serves as an output terminal C. The output terminal C is connected with the gate terminal of the transistor Qa.

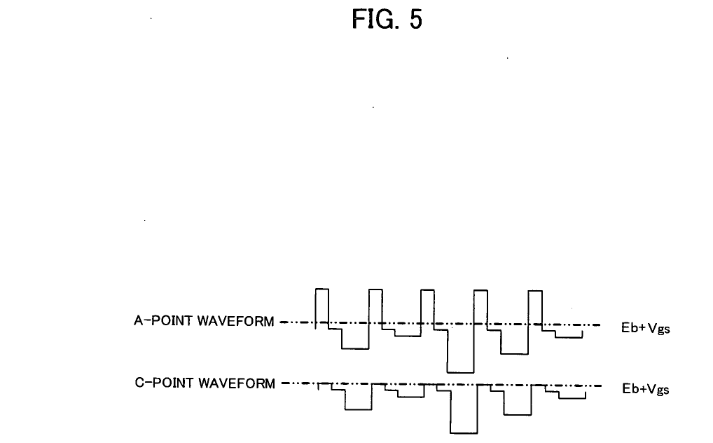

FIG. 5 shows the waveforms at the input terminal A and the output terminal C (i.e., the A-point waveform and the C-point waveform) of the clip circuit 16. FIG. 5 shows the waveforms of internal signals of the CCD solid-state image pick-up device which includes the clip circuit. The signal fed at the input terminal A (the A-point waveform) is output (the C-point waveform) as it is clipped, when the level of this signal exceeds a voltage (Eb+Vgs) which is the sum of the voltage Eb which is applied upon the gate of the transistor Qf and the gate-source voltage Vgs.

As described above, as the voltage signal taken out due to the capacitor Ca of the floating diffusion amplifier 13 passes through the clip circuit 16, the signal which exceeds the voltage (Eb+Vgs), which is the sum of the voltage Eb and the gate-source voltage Vgs of the transistor Qf, is clipped from this voltage signal, and the signal as such is output as a current signal from the voltage-current conversion circuit 14.

With this structure, it is possible to remove a reset pulse, prevent current starvation during voltage-current conversion and obviate a distortion during voltage-current conversion.

Although the third embodiment above requires disposition of merely the clip circuit 16, the level shift circuit 15 described in relation to the second embodiment may be inserted before or after the clip circuit 16. This structure more securely prevents a distortion.

In addition, the clip circuit 16 above has a structure which clips the signal which exceeds the total voltage (reference voltage) of the voltage Eb and the gate-source voltage Vgs of the transistor Qf, a structure which clips the signal which is below the reference voltage can be easily realized.

### Fourth Embodiment

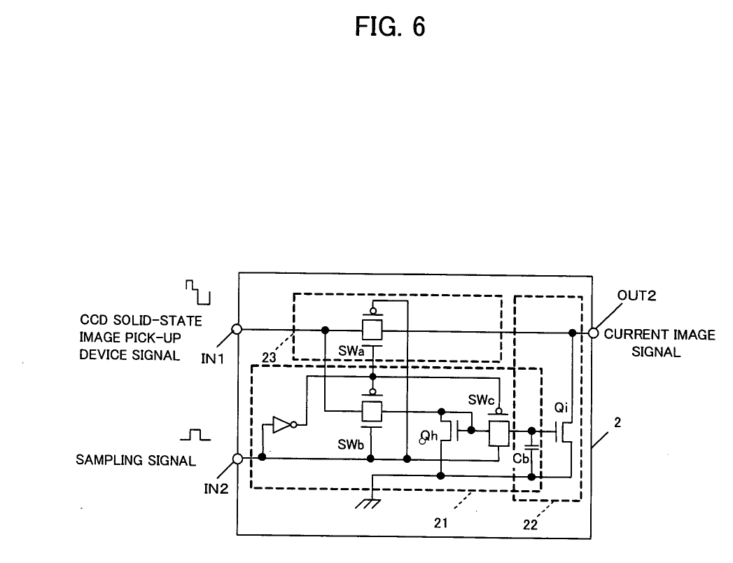

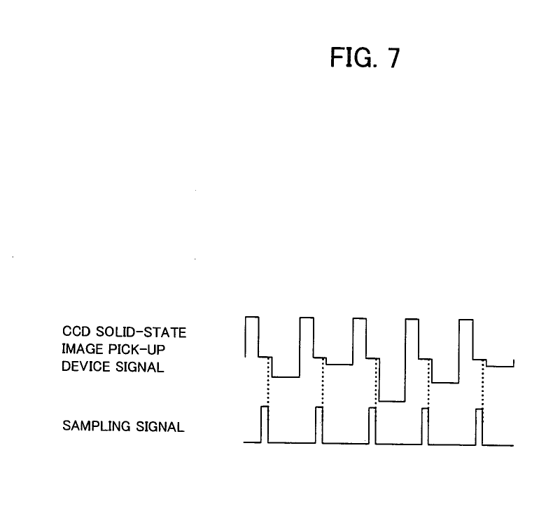

FIG. 6 is a circuitry block diagram which shows the structure of a current-driven black signal component detect/remove circuit according to the fourth embodiment of the present invention. FIG. 7 is a waveform diagram which shows the relationship between the waveform of an input signal to the current-driven black signal component detect/remove circuit of FIG. 6 and the waveform of a sampling signal.

In FIG. 6, the current-driven black signal component detect/remove circuit 2 is formed by a black signal current component detect/remove circuit 21, a variable current source circuit 22 and a signal transmission circuit 23.

In the current-driven black signal component detect/remove circuit 2, the current signal from the CCD solid-state image pick-up device, namely, a CCD solid-state image pick-up device signal is fed to a sample hold input terminal IN1, the sampling signal is fed to a sampling signal input terminal IN2, and the current image signal is output at an output terminal OUT2.

The current-driven black signal component detect/remove circuit 2 is used for removal of the black signal component from the image signal in an analog signal processing system for CCD solid-state image pick-up device.

The black signal current component detect/remove circuit 21 is formed by an analog switch SWb, a MOS transistor Qh, an analog switch SWc and a capacitor Cb.

One end of the analog switch SWb is connected with the sample hold input terminal IN1. The drain of the MOS transistor Qh is connected with the other end of the analog switch SWb, the gate and the drain of the MOS transistor Qh are connected with each other, and the source of the MOS transistor Qh is grounded. One end of the analog switch SWc is connected with the gate of the MOS transistor Qh. One end of the capacitor Cb is connected with the other end of the analog switch SWc, and the other end of the capacitor Cb is grounded. The analog switches SWb and SWc are fed with and starved of power in accordance with the sampling signal.

The signal transmission circuit 23 is formed by an analog switch SWa. One end of the analog switch SWa is connected with the sample hold input terminal IN1 and the other end of the analog switch SWa is connected with the output terminal OUT2. The analog switch SWa is fed with and starved of power in accordance with the sampling signal.

The variable current source circuit 22 is formed by the capacitor Cb described above and a MOS transistor Qi. The gate of the MOS transistor Qi is connected with one end of the capacitor Cb, the source of the MOS transistor Qi is connected with the other end of the analog switch SWa and the output terminal OUT2, and the drain of the MOS transistor Qi is grounded. The variable current source circuit 22 functions as a black signal component remove circuit.

The size of the MOS transistor Qh and that of the MOS transistor Qi are equal to each other.

In the waveform diagram in FIG. 7, during the period in which the sampling signal is at the high level, the analog switches SWb and SWc are ON but the analog switch SWa is OFF. At this stage, the black signal component detect/remove circuit 21 holds in the capacitor Ca a voltage with which the black signal current component can be passed on to the transistor Qi.

Next, during the period in which the sampling signal is at the low level, the analog switch SWa is ON but the analog switches SWb and SWc are OFF. At this stage, the current image signal passes through the signal transmission circuit 23. In addition, the variable current source circuit (black signal component remove circuit) 22 removes at this stage the black signal component (current component) contained in the current image signal. Describing in more detail, the black signal current component whose value corresponds to the gate voltage held in the capacitor Cb is extracted out from the current image signal by the transistor Qi. In consequence, the signal obtained by removing only the black signal current component from the current image signal which has passed through the signal transmission circuit 23 is output at the final output terminal OUT2.

### Fifth Embodiment

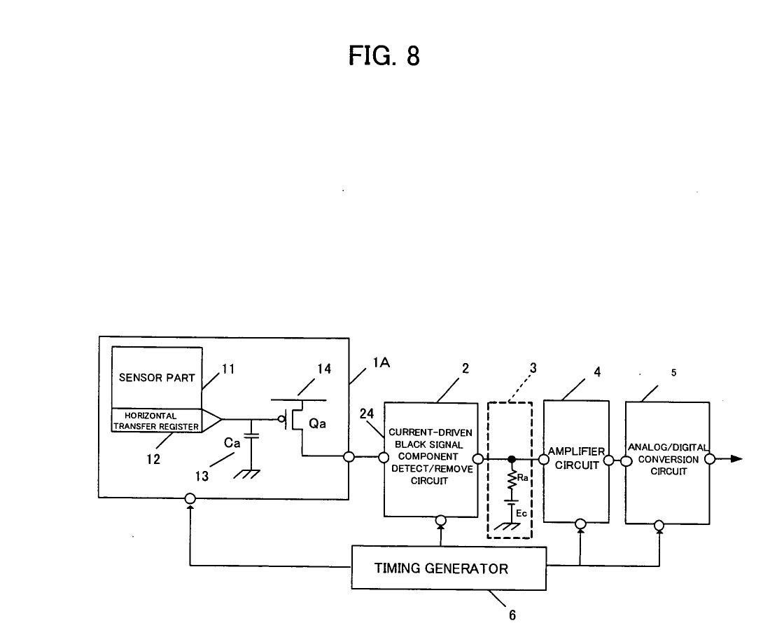

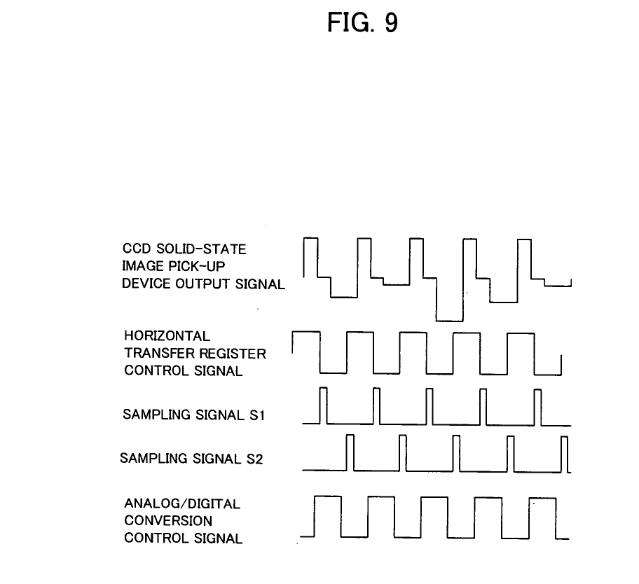

FIG. 8 is a circuitry block diagram which shows the structure of an analog signal processing system for a CCD solid-state image pick-up device according to the fifth embodiment of the present invention. FIG. 9 is a waveform diagram which shows the waveforms of signals generated by a timing generator.

In FIG. 8, denoted at 1A is the CCD solid-state image pick-up device. In the CCD solid-state image pick-up device 1A, electric charge information regarding each pixel vertically transferred from the sensor part 11 is transferred through the horizontal transfer register 12 in accordance with the horizontal transfer register control signal and converted by the floating diffusion amplifier 13 into a voltage signal. This voltage signal is subjected to voltage-current conversion by the voltage-current conversion circuit 14 and the voltage-current conversion circuit 14 then outputs this as a current signal. This current signal is a CCD solid-state image pick-up device output signal.

Denoted at 2 is the current-driven black signal component detect/remove circuit. This current-driven black signal component detect/remove circuit has the structure which is shown in FIG. 6. Denoted at 3 is the voltage-current conversion circuit which is formed by a resistor Ra and a bias power source having a bias voltage Ec. Denoted at 4 is an amplifier circuit which amplifies signals. Denoted at 5 is an analog-digital conversion circuit. Denoted at 6 is a timing generator. Denoted at 24 is an input terminal of the current-driven black signal component detect/remove circuit. The voltage-current conversion circuit 3 corresponds to a second conversion circuit.

Due to the voltage-current conversion circuit 14 described above, the CCD solid-state image pick-up device 1A outputs a current signal. The current signal output from the CCD solid-state image pick-up device 1A is connected directly with the input terminal 24 of the current-driven black signal component detect/remove circuit. The current-driven black signal component detect/remove circuit 2 removes the black signal from the current signal of the CCD solid-state image pick-up device 1A, whereby the image signal component alone is extracted. The voltage-current conversion circuit 3 formed by the resistor Ra and the bias power source having a bias voltage Ec converts the image signal component into a voltage signal. The voltage signal is transmitted to the analog-digital conversion circuit 5 via the amplifier circuit 4. The signals between these circuits are under the control of synchronized signal pulses as those shown in FIG. 9 which are generated by the timing generator 6.

The synchronized signal pulses shown in FIG. 9 will now be described. FIG. 9 shows the CCD solid-state image pick-up device signal, and the horizontal transfer register control signal, the sampling signals S1 and S2 and an analog-digital conversion control signal which are output from the timing generator 6.

The photo signal output (CCD solid-state image pick-up device signal) from the CCD solid-state image pick-up device 1A is transferred in the horizontal direction in accordance with the horizontal transfer register control signal, and then output. Next, the voltage-current conversion circuit 2 detects the level of the black signal contained in the CCD solid-state image pick-up device signal while the sampling signal S1 remains at the high level, and compares the image signal level with the black signal level while the sampling signal S1 remains at the low level and outputs a difference between the two. The amplifier circuit 4 monitors the signal which is input while the sampling signal S2 remains at the high level, and amplifies the signal while the sampling signal S2 remains at the low level. At last, the analog-digital conversion circuit 5 is driven by the analog-digital conversion control signal and converts the output signal of the amplifier circuit 4 from analog to digital.

In this structure that the output from the CCD solid-state image pick-up device 1A is fed directly to the voltage-current conversion circuit 2, it is possible to drive the voltage-current conversion circuit 2 with a small current. Hence, as compared with where a conventional voltage-driven black signal component detect/remove circuit is used and a buffer circuit is disposed before an input part of the voltage-driven black signal component detect/remove circuit, it is possible to more greatly reduce the amounts of the voltage and the current in the last stage of the output part of the CCD solid-state image pick-up device. This realizes low electric power consumption in the CCD solid-state image pick-up device 1A. At the same time, the reduced amount of heat developing within the CCD solid-state image pick-up device suppresses a white spot and shading.

Further, it is not necessary to dispose an impedance conversion circuit between the solid-state image pick-up device 1A and the current-driven black signal component detect/remove circuit 2. This attains reduction of the total electric power by approximately 20% in the analog signal processing system for the CCD solid-state image pick-up device.

Although this embodiment uses the CCD solid-state image pick-up device 1A, either the CCD solid-state image pick-up device 1B or 1C may be used instead.

In addition, although the voltage-current conversion circuit 14 is disposed inside the CCD solid-state image pick-up device 1A according to this embodiment, this voltage-current conversion circuit may be disposed outside the CCD solid-state image pick-up device. Further, where the voltage-current conversion circuit is disposed outside the CCD solid-state image pick-up device, at least one of the level shift circuit and the clip circuit may be disposed inside the CCD solid-state image pick-up device.

### Sixth Embodiment

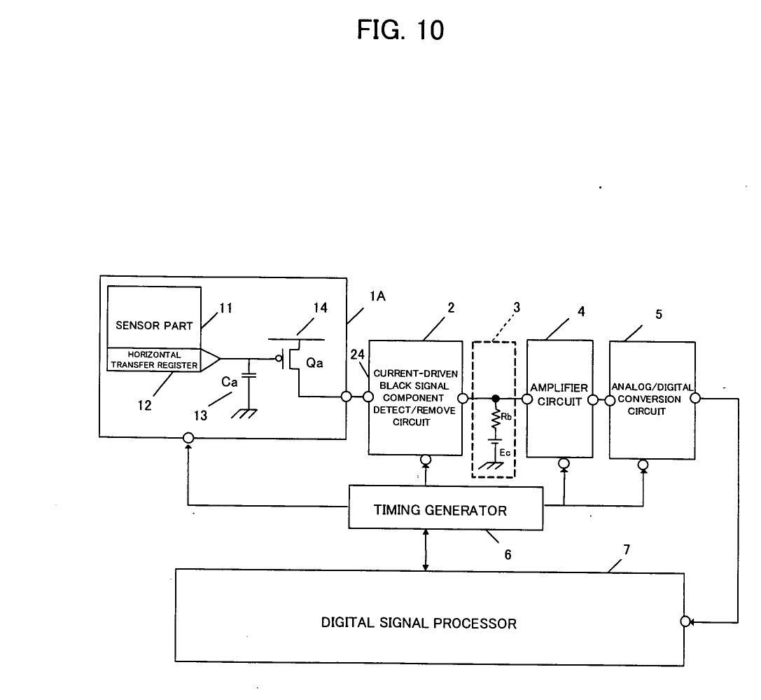

FIG. 10 is a circuitry block diagram which shows the structure of a camera system according to the sixth embodiment of the present invention.

In FIG. 10, denoted at 7 is a digital signal processor which processes a digital image signal which is output from the analog-digital conversion circuit 5. This camera system is for making the digital signal processor 7 perform image processing on the digital image signal which is output from the analog signal processing system for the CCD solid-state image pick-up device which is shown in FIG. 8.

This structure brings about similar effects to those according to the fifth embodiment.

Although the embodiment above uses the CCD solid-state image pick-up device 1A, either the CCD solid-state image pick-up device 1B or 1C may be used instead. Further, the voltage-current conversion circuit may be disposed outside the CCD solid-state image pick-up device.

### INDUSTRIAL APPLICABILITY

The CCD solid-state image pick-up device according to the present invention realizes an effect that it is possible to reduce the amount of internal heat generation, and as such is useful as an image pick-up device or the like incorporated inside a digital video camera.

1. A CCD solid-state image pick-up device, comprising:
a solid-state image pick-up circuit which converts a photo signal into a voltage signal and outputs said voltage signal; and
a first conversion circuit which converts said voltage signal into a current signal and outputs said current signal.

2. The CCD solid-state image pick-up device of claim 1, wherein said solid-state image pick-up circuit converts said photo signal into an electric signal temporarily and thereafter converts said electric signal into said voltage signal.

3. The CCD solid-state image pick-up device of claim 1, further comprising a level shift circuit which is disposed between said solid-state image pick-up circuit and said first conversion circuit and which changes the level of a d.c. component of said voltage signal.

4. The CCD solid-state image pick-up device of claim 1, further comprising a clip circuit which is disposed between said solid-state image pick-up circuit and said first conversion circuit and which removes said voltage signal which exceeds a predetermined reference signal.

5. The CCD solid-state image pick-up device of claim 1, further comprising:
a level shift circuit which is disposed between said solid-state image pick-up circuit and said first conversion circuit and which changes the level of a d.c. component of said voltage signal; and
a clip circuit which is disposed between said solid-state image pick-up circuit and said first conversion circuit and which removes said voltage signal which exceeds a predetermined reference signal.

6. The CCD solid-state image pick-up device of claim 5, wherein said level shift circuit is connected before said clip circuit.

7. The CCD solid-state image pick-up device of claim 5, wherein said level shift circuit is connected after said clip circuit.

8. An analog signal processing system, comprising:
a CCD solid-state image pick-up device which comprises a solid-state image pick-up circuit, which converts a photo signal into a voltage signal and outputs said voltage signal, and a first conversion circuit which converts said voltage signal into a current signal and outputs said current signal;
a remove circuit which removes a black signal component from said current signal and outputs a current image signal consisting only of an image signal component;
a second conversion circuit which converts said current image signal into a voltage image signal;
an amplifier circuit which amplifies said voltage image signal; and
an analog-digital conversion circuit which subjects an output signal from said amplifier circuit to analog-digital conversion.

9. An analog signal processing system, comprising:
a CCD solid-state image pick-up device which converts a photo signal into a voltage signal and outputs said voltage signal;
a first conversion circuit which is connected with said CCD solid-state image pick-up device and which converts said voltage signal into a current signal;
a remove circuit which removes a black signal component from said current signal and outputs a current image signal consisting only of an image signal component;
a second conversion circuit which converts said current image signal into a voltage image signal;
an amplifier circuit which amplifies said voltage image signal; and
an analog-digital conversion circuit which subjects an output signal from said amplifier circuit to analog-digital conversion.

10. The analog signal processing system of claim 9, further comprising a level shift circuit which is disposed between said solid-state image pick-up device and said first conversion circuit and which changes the level of a d.c. component of said voltage signal.

11. The analog signal processing system of claim 9, further comprising a clip circuit which is disposed between said solid-state image pick-up device and said first conversion circuit and which removes said voltage signal which exceeds a predetermined reference signal.

12. The analog signal processing system of claim 9, further comprising:
a level shift circuit which is disposed between said solid-state image pick-up device and said first conversion circuit and which changes the level of a d.c. component of said voltage signal; and
a clip circuit which is disposed between said solid-state image pick-up device and said first conversion circuit and which removes said voltage signal which exceeds a predetermined reference signal.

13. The analog signal processing system of claim 12, wherein said level shift circuit is connected before said clip circuit.

14. The analog signal processing system of claim 12, wherein said level shift circuit is connected after said clip circuit.

15. The analog signal processing system of claim 8 which is a part of a camera system which comprises a digital signal processing circuit which processes a digital signal.

16. The analog signal processing system of claim 9 which is a part of a camera system which comprises a digital signal processing circuit which processes a digital signal.

17. An analog signal processing method, comprising:
a step of extracting a photo signal as a voltage signal by a CCD solid-state image pick-up device;
a step of converting said voltage signal into a current signal;
a step of removing a black signal component from said current signal and outputting a current image signal consisting only of an image signal component;
a step of converting said current image signal into a voltage image signal; and
a step of amplifying said voltage image signal and subjecting said amplified signal to analog-digital conversion.
